(19) United States
(12) Patent Application Publication
(10) Pub. No.: US 2023/0322501 A1
(43) Pub. Date: Oct. 12, 2023

(54) TRANSPORT ROBOT AND TRANSPORT SYSTEM

(71) Applicant: Zensho Holdings Co., Ltd., Tokyo (JP)

(72) Inventor: Takao KATSUYAMA, Tokyo (JP)

(21) Appl. No.: 18/024,136

(22) PCT Filed: Jul. 9, 2021
(86) PCT No.: PCT/JP2021/025953

§ 371 Date: Mar. 1, 2023

(30) Foreign Application Priority Data
Sep. 2, 2020 (JP) 2020-147678

(51) Int. Cl. B65G 47/84

(52) U.S. Cl. CPC B65G 47/846

(57) ABSTRACT

A transport robot (2) includes a main body (20), and a plurality of rotating bodies (30) provided on the main body (20) and rotatable about a rotation axis along a direction in which a pair of rails (102L, 102R) extends. The plurality of rotating bodies (30) include a first rotating body (30) having at least one arm (L1, L2) that is configured to abut on one (102L) of the pair of rails (102L, 102R) on a first side which is one side in a traveling direction of the transport robot (2) with respect to the main body (20); and a second rotating body (30) having at least one arm (R1, R2) that is configured to abut on the other (102R) of the pair of rails (102L, 102R) on a second side which is the other side in the traveling direction of the transport robot (2) with respect to the main body (20). In the up/down mode, the arms (L1, L2) of the first rotating body (30) and the arms (R1, R2) of the second rotating body (30) rotate in opposite directions to each other and move up/down between the pair of rails (102L, 102R) and the pair of rails (103L, 103R).

### FIELD OF THE INVENTION

The present invention relates to a transport robot and a transport system using the transport robot.

### BACKGROUND OF THE INVENTION

There has been proposed a transport system in which a transport robot can travel along a traveling path installed in advance to pick up an article, and the transport robot can move not only to the traveling path on which the transport robot is traveling but also to a traveling path of an upper stage and a traveling path of a lower stage.

For example, Patent Document 1 discloses an automatic storage/retrieval system including a mobile robot. The mobile robot may horizontally move along a horizontal track, and may vertically move to another horizontal track through a ramp installed to diagonally intersect the plurality of horizontal tracks. As shown in FIGS. 39B and 41B of Patent Document 1, the ramp includes a chain that engages with and lifts up a sprocket wheel of the mobile robot.

### PRIOR ART DOCUMENT

### Patent Document

[Patent Document 1] JP 2018-517646 T

### SUMMARY OF THE INVENTION

### Problems to be Solved by the Invention

However, in the known configuration as described in Patent Document 1, a place where the transport robot can move up/down is limited to a hoistway dedicated for moving up/down provided at a specific place of the traveling path. Therefore, an object of the present invention is to provide a transport robot that is configured to move up/down at an arbitrary place of a structure, and a transport system using the robot.

### Means for Solving the Problem

A transport system according to one aspect of the present invention includes a structure in which a plurality of pairs of rails are vertically arranged, and a transport robot configured to travel on the rails and move up/down between the vertically arranged plurality of pairs of rails. A structure according to another aspect of the present invention is a structure in which a plurality of pairs of rails extending along a traveling path of a transport robot are vertically arranged. A transport robot according to another aspect of the invention includes a main body; and a plurality of rotating bodies provided in the main body and rotatable about a rotation axis along a direction in which the pair of rails extends. The plurality of rotating bodies include a first rotating body having at least one arm configured to abut on one of the pair of rails on a first side which is one side in a traveling direction of the transport robot with respect to the main body, and a second rotating body having at least one arm configured to abut on the other one of the pair of rails on a second side which is the other side in the traveling direction of the transport robot with respect to the main body. In the up/down mode, the arm of the first rotating body and the arm of the second rotating body rotate in opposite directions to each other to move up/down between the pair of rails.

According to these aspects, when the transport robot moves up between the plurality of pairs of rails arranged vertically, the transport robot can move up between the plurality of pairs of rails by abutting an abutting portion of at least one of the arms on the first side and the second side on the rail on the first side or the second side of the pair of rails located below to support its own weight, and abutting an abutting portion of the other arm on the rail on the first side or the second side of the pair of rails located above to pull up its own weight while rotating the first rotating body and the second rotating body in opposite directions to each other. At this time, the rotation direction of each arm is determined such that the main body rotates in a rising direction in a state in which at least one arm abuts on the rail. In addition, when the transport robot moves down between the plurality of pairs of rails arranged vertically, the transport robot can move down between the plurality of pairs of rails by abutting and hanging an abutting portion of at least one of the arms on the first side and the second side on the rail on the first side or the second side of the pair of rails located above, and approaching and landing an abutting portion of the other arm on the rail on the first side or the second side of the pair of rails located on below while rotating the arm on the first side and the arm on the second side in opposite directions to each other. At this time, the rotation direction of each arm is determined such that the main body rotates in a rising direction in a state in which at least one arm abuts on the rail. Therefore, the transport robot can move up/down at an arbitrary place of a structure in which a plurality of pairs of rails are vertically arranged.

In the above aspect, at least a first arm and a second arm may be provided as the arm on the first side, and at least a third arm and a fourth arm may be provided as the arm on the second side. Furthermore, in a mode in which the transport robot moves up/down, the first arm as well as the second arm, and the third arm as well as the fourth arm are rotated in opposite directions to each other to move up/down between the pair of rails such that in a state in which one of the first arm and the second arm is configured to abut on the rail of the lower stage located below a rotation center of the arm, the other one of the first arm and the second arm is configured to abut on the rail of the upper stage located above the rotation center of the arm, and in a state in which one of the third arm and the fourth arm is configured to abut on the rail of the lower stage located below the rotation center of the arm, the other one of the third arm and the fourth arm is configured to abut on the rail of the upper stage located above the rotation center of the arm.

According to this aspect, the transport robot can move up to the rail of the upper stage by abutting the arm on the rail of the lower stage than the rotation center of the arm to support its own weight and abutting the arm on the rail of the upper stage than the rotation center of the arm to pull up its own weight. The arm is abutted on and hanged from the rail of the upper stage than the rotation center of the arm, and the arm is approached and landed on the rail of the lower stage than the rotation center of the arm, whereby it can be lowered to the rail of the lower stage. Therefore, the transport robot can move up/down at an arbitrary place of a structure in which a plurality of pairs of rails are vertically arranged.

In the above aspect, a pair of wheels may be further provided. In a mode in which the transport robot travels, the wheel on the first side travels on the rail on the first side, and the wheel on the second side travels on the rail on the second side, and in a mode in which the transport robot moves up/down, the wheel on the first side may be retracted to the second side than the rail on the first side, and the wheel on the second side may be retracted to the first side than the rail on the second side.

According to this aspect, the wheel on the first side can be retracted to the second side than the rail on the first side, and the wheel on the second side can be retracted to the first side than the rail on the second side, and thus interference between the wheel and the rail can be prevented when the transport robot moves on the structure vertically. The wheel may be retracted by rudder angle rotation or the wheel may be retracted by linear movement of the wheel, or the like.

In the above aspect, a rudder angle variable mechanism configured to change the rudder angle of the pair of wheels may be further provided. In a mode in which the transport robot moves up/down, the rudder angle of the pair of wheels may be changed by the rudder angle variable mechanism, the wheel on the first side may be retracted to the second side than the rail on the first side, and the wheel on the second side may be retracted to the first side than the rail on the second side.

According to this aspect, the wheel on the first side can be retracted to the second side than the rail on the first side, and the wheel on the second side can be retracted to the first side than the rail on the second side by the rudder angle rotation using the rudder angle variable mechanism.

In the above aspect, the transport robot may include at least two sets of the pair of wheels, and a rudder angle of each of the wheels may be individually changed.

According to this aspect, for example, if the front wheels are made orthogonal to each other, the rear wheels are made orthogonal to each other, and the wheels located diagonally on the main body are made parallel to each other, the transport robot can turn 360 degrees like a spinning top around a position that is equidistant from all the wheels. When a place for changing the direction is provided in the structure, the transport robot can change the direction even in a narrow place.

In the above aspect, a wheel moving mechanism configured to move the pair of wheels in a direction orthogonal to a direction in which the rails extend may be further provided. In the mode in which the transport robot moves up/down, an interval between the pair of wheels is changed by the wheel moving mechanism; the wheel on the first side is retracted to the second side than the rail on the first side, and the wheel on the second side is retracted to the first side than the rail on the second side.

According to this aspect, the wheel on the first side can be retracted to the second side than the rail on the first side, and the wheel on the second side can be retracted to the first side than the rail on the second side by the linear movement using the wheel moving mechanism.

In the above aspect, the transport robot may further include a second guided portion configured to restrict movement of the transport robot toward the first side or the second side by abutting on the structure in a mode in which the transport robot travels. The second guided portion configured to restrict the movement to the first side may be attached to the wheel on the first side and projected out further to the first side than the wheel. The second guided portion configured to restrict the movement to the second side may be attached to the wheel on the second side and projected out further to the second side than the wheel.

According to this aspect, by abutting the second guided portion on the structure to restrict the movement to the first side or the second side, the meandering of the transport robot during traveling or the deviation of the traveling path of the transport robot to either the first side or the second side can be suppressed, and for example, the transport robot can be prevented from going off course from the rail during traveling. Even if the transport robot travels at a high speed, the transport robot is less likely to go off course, so that the transport robot can travel at a higher speed.

In the above aspect, the structure may further include an up/down guide provided between the rail of the upper stage and the rail of the lower stage. The transport robot may further include a first guided portion configured to restrict movement of the transport robot toward the first side or the second side by abutting on the structure in a mode in which the transport robot moves up/down. The first guided portion may be a circular member. The first guided portion configured to restrict the movement to the first side may be provided between an abutting portion of the arm on the first side and a rotation center of the arm, and the first guided portion configured to restrict the movement to the second side is provided between an abutting portion of the arm on the second side and a rotation center of the arm.

According to this aspect, when the transport robot moves up/down the structure, the first guided portion can be abutted on the guide portion of the structure to prevent positional displacement therebetween. The transport robot can be smoothly moved up/down, and the transport robot can be prevented from being unable to move when the arm cannot abut against the rail by preventing the positional displacement.

In the above aspect, the transport robot may further include an inter-center distance variable mechanism configured to change a distance between a rotation center of the arm on the first side and a rotation center of the arm on the second side

According to this aspect, since the distal end of each arm draws a trajectory that revolves around the rotation center, the position at which the arm and the rail abut against each other is slightly displaced according to the angle of the arm. According to this aspect, the rotation center is moved such that the distal end of the arm follows the predetermined position of the rail, and the positional displacement between the arm and the rail can be prevented.

### Effects of the Invention

According to the present invention, a transport robot configured to move up/down at an arbitrary place of a structure in which a plurality of pairs of rails are vertically arranged, and a transport system using the transport robot can be provided.

### BRIEF DESCRIPTION OF THE DRAWINGS

FIG. 1 is a perspective view illustrating an example of a transport system common to each embodiment of the present invention.

FIG. 2 is a perspective view showing a transport robot according to a first embodiment of the present invention;

FIG. 3 is a view for explaining an operation in which the transport robot moves up/down, and is a front view illustrating the transport robot in a traveling mode.

FIG. 4 is a view continuing from FIG. 3, and is a front view illustrating a state in which a wheel floated by rotating an arm is retracted.

FIG. 5 is a view continuous from FIG. 4 and is a front view illustrating a state in which the arm abuts on both the rails of the upper stage and the lower stage.

FIG. 6 is a view continued from FIG. 5 and is a front view showing a state in which the wheel is pulled up higher than the rail of the lower stage.

FIG. 7 is a perspective view showing a traveling mode of the transport robot according to a second embodiment of the present invention.

FIG. 8 is a perspective view showing an up/down mode of the transport robot shown in FIG. 7.

FIG. 9 is a perspective view showing an example of a transport robot according to a third embodiment of the invention.

FIG. 10 is a view for describing the operation in which the transport robot moves up/down, and is a front view illustrating an example of the transport robot in a

FIG. 11 is a view continuing from FIG. 10, and is a front view illustrating a state in which a wheel floated by rotating an arm is retracted.

FIG. 12 is a view continued from FIG. 11 and is a front view showing a state in which the arm pulls up the wheel using the rail of the lower stage as a scaffold.

FIG. 13 is a view continuous from FIG. 12 and is a front view illustrating a state in which the arm abuts on both the rails of the upper and lower stages.

FIG. 14 is a view continued from FIG. 13 and is a front view showing a state in which the wheel is pulled up higher than the rail of the lower stage.

### DESCRIPTION OF THE PREFERRED EMBODIMENT

Preferred embodiments of the present invention will be described with reference to the accompanying drawings. Note that, in the respective drawings, components denoted by the same reference numerals have the same or similar configurations. For convenience of description of the embodiment, “upper” and “lower” are defined on the basis of gravity, and “front”, “rear”, “left”, and “right” are defined on the basis of the traveling direction of the transport robot 2 on the rail. The transport robot 2 according to each embodiment of the present invention can travel over a pair of rails arranged on the left and right with respect to the advancing direction of the transport robot 2.

One of the features of the transport robot 2 of each embodiment is that the same rail can be used as both the traveling path in the traveling mode and the hoistway in the moving up/down mode. Hereinafter, each embodiment will be described in detail with reference to the drawings.

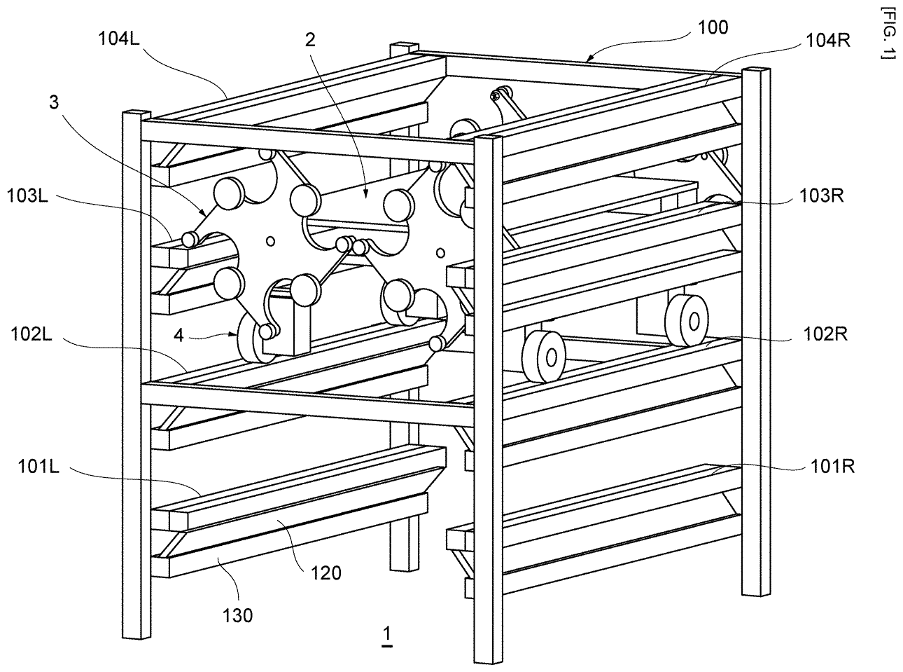

FIG. 1 is a perspective view illustrating an example of a transport system 1 common to each embodiment of the present invention. As shown in FIG. 1, a transport system 1 includes a structure 100 in which a plurality of pairs of rails (101L, 101R) . . . (104L, 104R) extending along a traveling path of a transport robot 2 are vertically arranged, and the transport robot 2 that is configured to travel on the rails and configured to move up/down in the structure 100.

A traveling mechanism 4 and an up/down mechanism 3 of the transport robot 2 abut on the upper surface of the rail. Each of the rails is formed in a bar shape having a substantially flat upper surface. Fine irregularities may be provided on the upper surface to prevent slipping, and the like. The material of the rail is not particularly limited, and may be metal or resin. Each of the rails may extend linearly or may extend in a curved manner.

The width of the upper surface is formed to be wider than the width of a wheel 41 of the transport robot 2. The shape other than the upper surface is not particularly limited, and the cross section of the rail may be rectangular or may be another shape. Rails having different cross-sectional shapes may coexist and vertically arranged. In the vertically arranged rails, an interval from an upper surface of an arbitrary rail (e.g., 102L) to an upper surface of a rail 103L one stage above the rail 102L is equal to an interval from an upper surface of the arbitrary rail 102L to an upper surface of a rail 101L one step below the rail 102L.

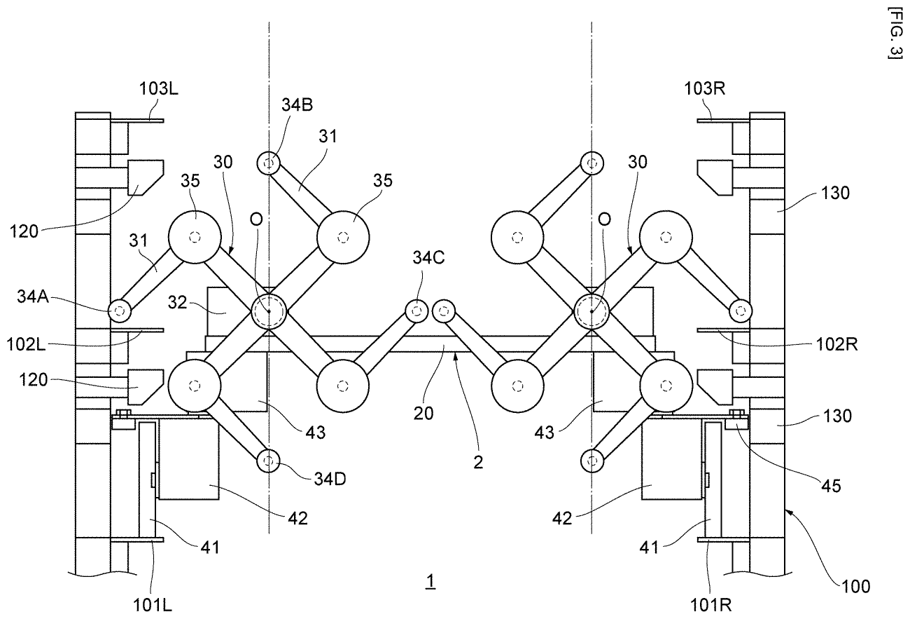

In the structure 100, rails located at the same height and having different extending directions may be connected by a flat plate. The transport robot 2 can be used as a direction changing space for changing the direction. The rails having the same height and different extending directions may be connected by a curved rail. The structure 100 may further include an up/down guide 120 that guides the movement of the transport robot 2 while moving up/down, a traveling guide 130 that guides the movement of the transport robot 2 while traveling, and the like. The up/down guide 120 and the traveling guide 130 will be described later with reference to FIGS. 3 to 6.

The transport system 1 is used, for example, in a restaurant or a distribution warehouse.

When the transport system 1 is used for a restaurant, the tray on which the dish is placed may be transported from the pantry to the hall by traveling on for example, the rails 104L and 104R of the upper stage, and the tray on which the empty plate is placed may be transported from the hall to the washing place by traveling on, for example, the rails 101L and 101R of the lower stage.

A rail on which a product is to be provided and a rail on which an empty dish is to be bussed can be distinguished and arranged vertically. As compared with a case where a common rail is used for the outward path of providing a product and the return path of bussing an empty dish, the rail for the outward path can be hygienically maintained. An occupying area of the structure 100 can be reduced as compared with a case where rails having different purposes are arranged on the left and right. When the transport system 1 is used in a warehouse, for example, the transport system 1 can be used as a transport means of a container or the like in the warehouse.

Note that the structure 100 does not need to have rails provided vertically in a plurality of stages at all sites. Depending on the shape and layout of the restaurant or the distribution warehouse, a location where the rail is a single stage may exist in one part thereof. By providing the rails vertically in a plurality of stages at least a part of the structure, the transport robot 2 may be moved up/down in the relevant region.

### First Embodiment

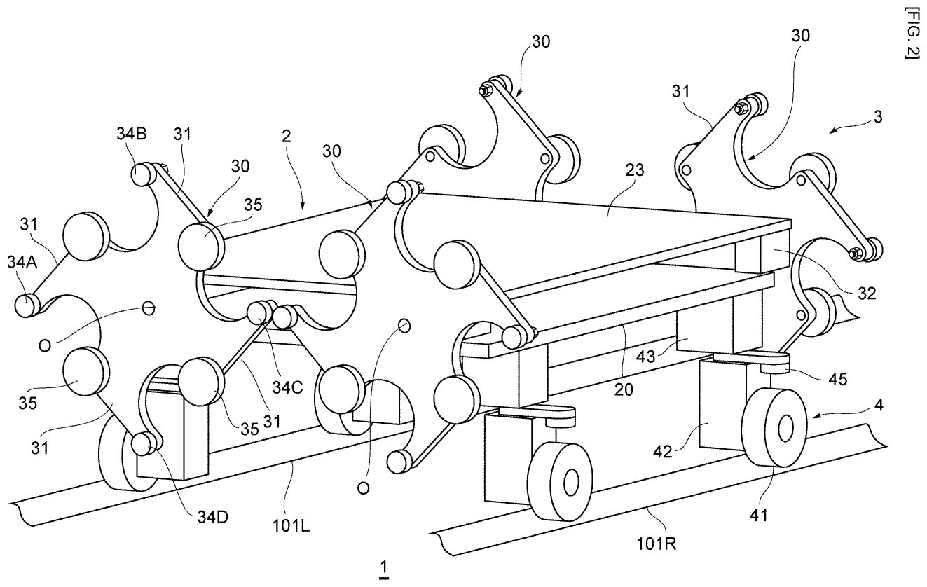

FIG. 2 is a perspective view illustrating the transport robot 2 according to the first embodiment of the present invention. The transport robot 2 includes a main body 20, and an up/down mechanism 3 and a traveling mechanism 4 assembled to the main body 20. The up/down mechanism 3 is used in an up/down mode in which the transport robot 2 moves the structure 100 vertically, and the traveling mechanism 4 is used in a traveling mode in which the transport robot 2 moves the structure 100 horizontally. The main body 20 includes a controller that controls operations of the up/down mechanism 3 and the traveling mechanism 4.

The up/down mechanism 3 includes an arm plate 30 configured to be rotatable and an arm driving unit 32 that rotationally drives the arm plate 30. At least one arm plate 30 is provided on each of the first side (e.g., the left side) and the second side (e.g., the right side) of the transport robot 2. The arm plate 30 is an example of a rotating body in the present embodiment. Each arm plate 30 includes at least one arm 31. In the illustrated example, each arm plate 30 is formed in a hooked cross shape, and includes four arms 31 disposed at equal intervals of 90° in the clockwise direction of the rotation axis passing through the rotation center O of the arm plate 30.

The arm plate 30 (an example of a first rotating body) attached to the left side of the main body 20 and the arm plate 30 (an example of a second rotating body) attached to the right side of the main body 20 are formed symmetrically and rotate in opposite directions to each other. The left side of the main body 20 is an example of the first side, and the right side is an example of the second side. The right side may be the first side, and the left side may be the second side. The distal end of each arm 31 is provided with abutting portions 34A to 34D that is configured to abut on the rail.

In FIG. 2, the abutting portions 34A to 34D are formed in a disk shape and are constituted by rollers having a rotation axis parallel to the rotation axis of the arm 31. When the arm plate 30 rotates in the up/down mode (see FIGS. 3 to 6) described later, the abutting portions 34A to 34D slightly move in the width direction of the rail while making sliding contact with the upper surface of the rail. When the rotatable rollers are provided on the abutting portions 34A to 34D, friction between the abutting portions 34A to 34D and the rail can be reduced by rolling of the rollers, and generation of dust can be suppressed.

The traveling mechanism 4 includes at least a pair of wheels 41 that is configured to travel on the rails, a wheel driving unit 42 that rotationally drives the wheels 41, and a turn driving unit 43 that changes a rudder angle of the wheels 41. In FIG. 2, the main body 20 is formed in a substantially rectangular flat plate shape, and the arm plate 30 and the wheel 41 are attached to four corners of the main body 20 one by one. That is, the transport robot 2 includes two sets of the pair of left and right arm plates 30 and two sets of the pair of left and right wheels 41.

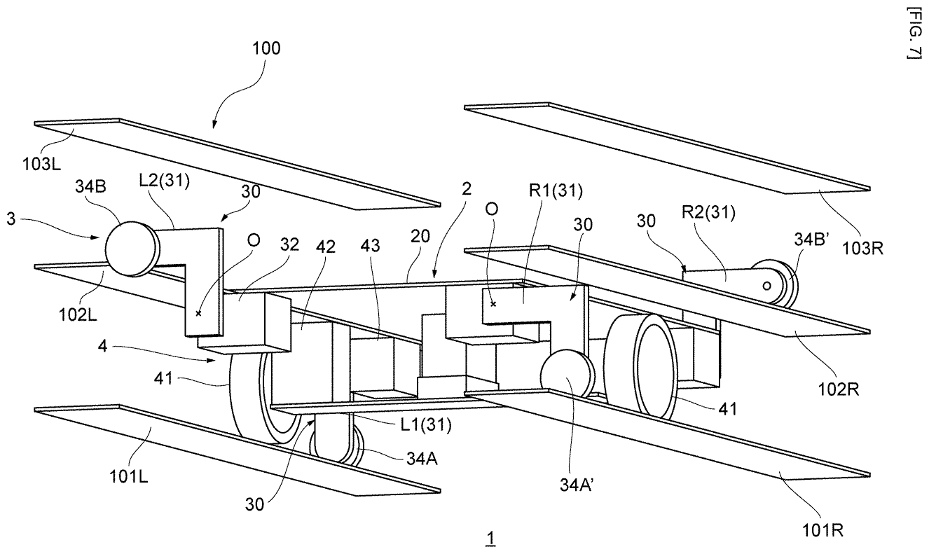

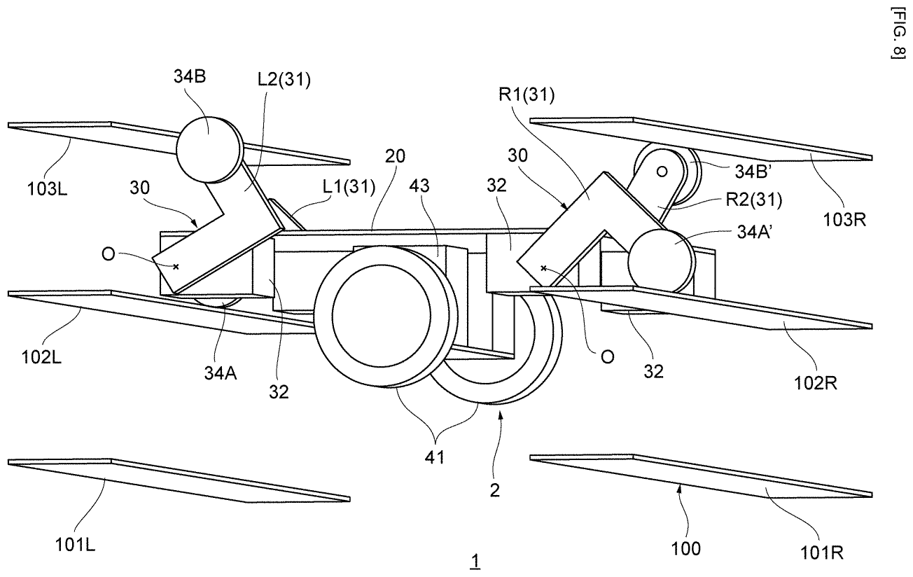

The configurations of the arm plate 30 and the wheel 41 are not limited to the illustrated example. The transport robot 2 may include only one set or three or more sets of the pair of arm plates 30. The transport robot 2 may include only one set or three or more sets of the pair of wheels 41. Other configurations will be described in detail in a second embodiment with reference to FIGS. 7 and 8.

In FIG. 2, one arm driving unit 32 is provided in correspondence with each arm plate 30, and one wheel driving unit 42 is provided in correspondence with each wheel 41. One arm driving unit 32 may be configured to collectively drive the plurality of arm plates 30. Similarly, one wheel driving unit 42 may be configured to collectively drive the plurality of wheels 41.

In FIG. 2, one turn driving unit 43 is provided in correspondence with each wheel 41. The configuration of the turn driving unit 43 is not limited to the illustrated example. One turn driving unit 43 may be provided in correspondence with the plurality of wheels 41. The turn driving unit 43 is formed in a substantially rectangular parallelepiped shape and connects the main body 20 and the wheel driving unit 42.

An output shaft provided at the center of the lower surface of the turn driving unit 43 is fixed at a position eccentric from the center of the upper surface of the wheel driving unit 42. An output shaft of the wheel driving unit 42 extends in the horizontal direction and is fixed to an axle of the wheel 41. The wheel 41 is located on the opposite side of the output shaft of the wheel driving unit 42 as viewed from the center of the upper surface of the steering driving unit 43. That is, the wheel 41 viewed from the output shaft of the steering driving unit 43 is located at a position further away from the center of the upper surface of the wheel driving unit 42.

The turn driving units 43 provided on the four wheels can rotate the wheel driving unit 42 about the vertical axis to change the rudder angle of the wheel 41 immediately below each wheel driving unit 42. When the rudder angles of the front wheel and the rear wheel are both zero, the transport robot 2 travels straight, and when the rudder angle of at least one of the front wheel and the rear wheel is not zero, the transport robot 2 travels while turning. In any case, when the transport robot 2 travels straight or turns a curve, the left and right front wheels have the same rudder angle and are parallel to each other, and the left and right rear wheels have the same rudder angle and are parallel to each other.

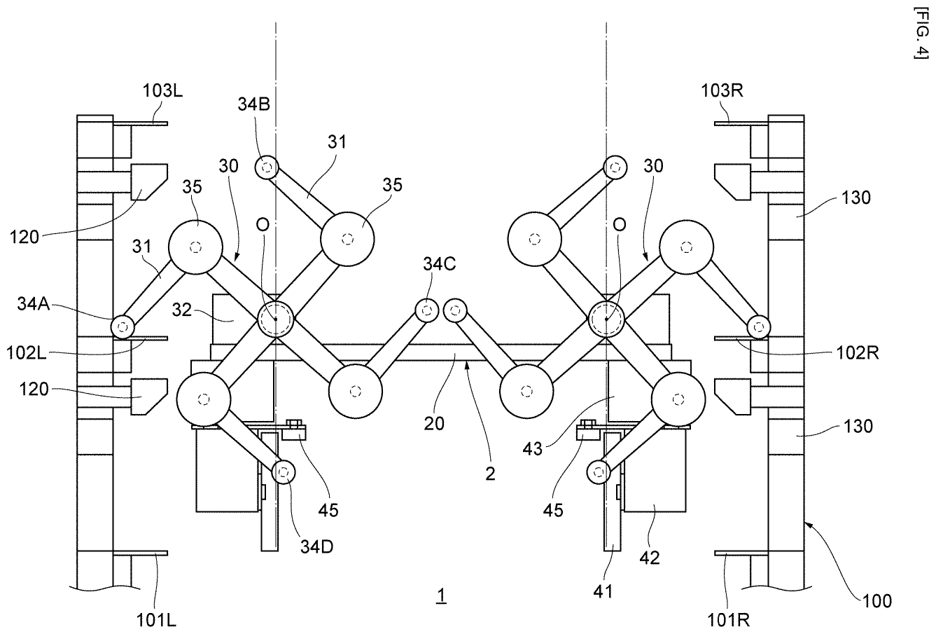

In the transport robot 2 of the present embodiment, the rudder angles of the left and right front wheels are configured to be individually changed, and the rudder angles of the left and right rear wheels are configured to be individually changed. In other words, the steering can be performed such that the left and right front wheels are not parallel but orthogonal to each other, the left and right rear wheels are not parallel but orthogonal to each other, and the wheels 41 located diagonally on the substantially rectangular main body 20 are parallel to each other. In this state, when the wheels 41 located diagonally to the main body 20 are rotated in opposite directions to each other, the transport robot 2 turns 360 degrees around the center of the main body 20 like a spinning top. Since the transport robot 2 of the present embodiment capable of individually changing the rudder angle of the four wheels can turn 360 degrees on the spot without moving forward, the transport robot 2 can change the direction even in a narrow place such as the direction changing space described above. The turn driving unit 43 can retract each of the wheels 41 so that the wheels 41 do not interfere with the rails 102L and 102R by changing the rudder angle of the wheels 41. The retraction of the wheels 41 will be described later with reference to FIGS. 3 and 4.

In FIG. 2, the up/down mechanism 3 of the transport robot 2 further includes a first guided portion 35, and the traveling mechanism 4 further includes a second guided portion 45. The first guided portion 35 restricts the movement of the transport robot 2 to the left side or the right side by abutting on the up/down guide 120 of the structure 100 in the up/down mode in which the transport robot 2 moves up/down the structure 100. Similarly, the second guided portion 45 restricts the movement of the transport robot 2 to the left side or the right side by abutting on the traveling guide 130 of the structure 100 in the traveling mode in which the transport robot 2 travels on the structure 100.

In FIG. 2, the first guided portion 35 is a rotatable roller formed in a disk shape, and is attached to each arm 31. For example, the first guided portion 35 is disposed in a bent portion at an equidistant from both the rotation center O and the abutting portions 34A to 34D, and has a rotation axis parallel to the rotation axis of the arm 31.

In FIG. 2, the second guided portion 45 is a rotatable roller formed in a disk shape, and is attached to each wheel 41. The second guided portion 45 that restricts the transport robot 2 from moving to the left side is attached to the wheel 41 on the left side and projected out to the left side than the wheel 41. Similarly, the second guided portion 45 that restricts the transport robot 2 from moving to the right side is attached to the wheel 41 on the right side and projected out to the right side than the wheel 41. The second guided portion 45 does not necessarily need to be a rotatable roller, and may be a circular member.

In FIG. 2, the transport robot 2 further includes a tray lift mechanism 23 mounted on the main body 20. The tray lift mechanism is an area for placing a tray on the upper surface thereof, and is configured to move up/down by an appropriate up/down mechanism (not illustrated). According to the tray lift mechanism 23, for example, the transport robot 2 on standby on the rails 101L and 101R of the lower stage can lift the tray to the height of the rail of the upper stage or receive the tray from the height of the rail of the upper stage.

Next, an operation in which the transport robot 2 illustrated in FIG. 2 moves up/down the structure 100 will be described with reference to FIGS. 3 to 6. However, since FIGS. 3 to 6 schematically show shapes of the details, the shape of the arm or the like may be different from that in FIG. 2. As illustrated in FIG. 3, in the transport robot 2 in the traveling mode, the wheel 41 on the left side is not floated from the rail 101L on the left side immediately below and abuts on the rail, and the wheel 41 on the right side is not floated from the rail 101R on the right side immediately below and abuts on the rail.

The second guided portion 45 attached to the traveling mechanism 4 including the wheel 41 faces the traveling guide 130 of the structure 100 in the left-right direction. The arm plate 30 is installed on the main body 20 such that the abutting portions 34A to 34D of the respective arms 31 can be located on the first side or the second side of the main body 20. The abutting portions 34A to 34D of the arm 31 are spaced apart from the rails 102L and 102R.

When the transport robot 2 moves up from the rails 101L and 101R to the rails 102L and 102R one stage above in the up/down mode, the arm plate 30 is first rotated. Each arm 31 attached to the arm plate 30 rotates according to the rotation of the arm plate such that the abutting portions 34A to 34D draw a circular trajectory about the rotation center O. That is, the rotation center of the arm 31 and the rotation center of the arm plate 30 are concentric.

The height of the abutting portion 34A with respect to the rotation center O is represented by a displacement amount of a sine wave, and periodically changes according to the rotation angle of the arm 31. When the arm 31 rotates in a direction in which the height of the abutting portion 34A lowers (counterclockwise when viewed from the near side of the plane of drawing), the abutting portion 34A moves downward and eventually abuts on the rail 102L immediately below as illustrated in FIG. 4. When the arm 31 further rotates, the downward movement of the abutting portion 34A is inhibited by the rail 102L, and the abutting portion 34A cannot move downward.

At this time, the rotation center O moves relatively upward with respect to the abutting portion 34A. When the abutting portion 34A cannot move downward any further, the rotation center O moves upward by that amount. Since the arm driving unit 32 having the rotation center O is fixed to the main body 20, the main body 20 and the traveling mechanism 4 fixed to the main body 20 move upward together with the rotation center O.

That is, when the arm 31 is further rotated in this state, the rails 102L and 102R are pressed by the abutting portion 34A that tries to move downward, and the wheel 41 can be floated from the rails 101L and 101R by the reaction force thereof. Next, as illustrated in FIG. 4, the wheel 41 on the left side is retracted to the right side than the rail 102L on the left side and the wheel 41 on the right side is retracted to the left side than the rail 102R on the right side using the rudder angle variable mechanism.

As described above, the output shaft of the turn driving unit 43 is fixed to the upper surface of the wheel driving unit 42 at a position away from the wheel 41. When the rudder angle is changed by 180 degrees in a state where the wheel 41 is located on the outer side in the left-right direction as viewed from the output shaft of the turn driving unit 43, the wheel 41 revolves around the output shaft of the turn driving unit 43 and moves to the side opposite by 180 degrees as viewed from the shaft, that is, to the inner side in the left-right direction. The turn driving unit 43 is an example of a rudder angle variable mechanism, and can shorten the distance between the wheels according to the revolution radius of the wheels 41. As a result, the wheel is prevented from interfering with the rail during the up/down operation.

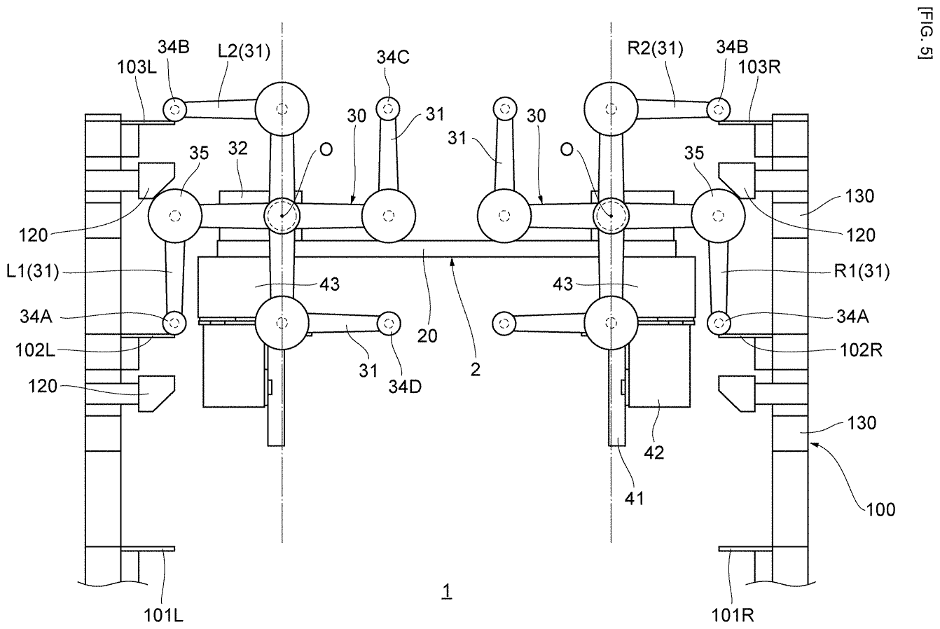

The arm 31 is further rotated, and the wheel 41 is pulled up together with the main body 20 using the rails 102L and 102R as a scaffold. As shown in FIG. 5, when the arms 31 indicated by the reference numerals L1 and R1 are further rotated, the other arms 31 indicated by the reference numerals L2. R2 abut with the rails 103L and 103R of the upper stage than the rails 102L, 102R. The interval between the upper surface of the rail 102L and the upper surface of the rail 103L on the upper and lower sides described above is substantially the same as or slightly smaller than the amplitude (maximum displacement amount) of the sine wave representing the height of the abutting portion 34.

The transport robot 2 of the present embodiment includes the first and second arms L1 and L2 provided at least one each on the first side (e.g., the left side) of the main body 20, and the third and fourth arms R1 and R2 provided at least one each on the second side (e.g., the right side) of the main body 20, and in a state where either one of the first and second arms L1 and L2 (e.g., the first arm L1) is configured to abut on the rail 102L of the lower stage located below the rotation center O of the arm, the other one of the first and second arms L1 and L2 (e.g., the second arm L2) is configured to abut on the rail 103L of the upper stage located above the rotation center O of the arm, and in a state where either one of the third and fourth arms R1 and R2 (e.g., the third arm R1) is configured to abut on the rail 102R of the lower stage located below the rotation center O of the arm, the other one of the third and fourth arms R1 and R2 (e.g., the fourth arm R2) is configured to abut on the rail 103R of the upper stage located above the rotation center O of the arm.

In the example illustrated in FIG. 5, each of the two front and rear arm plates 30 provided on the left side of the main body 20 in the depth direction in the plane of drawing includes the first and second arms L1 and L2, and each of the two front and rear arm plates 30 provided on the right side of the main body 20 in the depth direction in the plane of drawing includes the third and fourth arms R1 and R2.

In the example shown in FIG. 5, the up/down guide 120 that restricts the movement of the transport robot 2 to the left side is provided between the rail 102L and the rail 103L. Similarly, the up/down guide 120 that restricts the movement of the transport robot 2 to the right side is provided between the rail 102R and the rail 103R. The up/down guide 120 that restricts the movement to the left side is arranged, for example, on the movement trajectory of the first guided portion 35, and is formed as an inclined surface that is directed toward the right side as it is directed toward the above. The inclined surface is inclined by, for example, 45 degrees with respect to a virtual plane including the inner edge of the rail 102L and the inner edge of the rail 103L. The up/down guide 120 that restricts the movement to the right side is formed symmetrically with the up/down guide 120 that restricts the movement to the left side.

When the state illustrated in FIG. 4 is shifted to the state illustrated in FIG. 5, the first guided portion 35 provided in the arm 31 abuts on the up/down guide 120 provided in the structure 100, and the transport robot 2 is guided so as to be equidistant from the pair of left and right rails 103L and 103R. At this time, the contact portion between the first guided portion 35 and the up/down guide 120 serves as a fulcrum, and each abutting portion 34A of the first and third arms L1, R1 on the rail slidably moves toward the main body 20 accompanying the rotational motion of the arm plate 30, so that the wheel 41 is pulled up together with the main body 20. Since the transport robot 2 is guided so as to be equidistant from the pair of left and right rails 103L and 103R, the abutting portions 34A and 34B of the second and fourth arms L2 and R2 can come into contact with the rails 103L and 103R at desired positions.

When the second arm L2 and the fourth arm R2 are further rotated from the state shown in FIG. 5, the scaffold supporting the self-weight is switched from the rails 102L, 102R to the rails 103L, 103R of the upper stage than the rails 102L, 102R. With the rails 103L and 103R as the scaffold, the arm 31 can pull up the wheel 41 higher together with the main body 20.

After the abutting portion 34A of each arm 31 is spaced apart from the rails 102L, 102R, the abutting portion 34A slidably moves on the rails 103L, 103R in a direction away from the main body 20 accompanying the rotational motion of the arm plate 30 with the contact portion between the first guided portion 35 and the up/down guide 120 as a fulcrum, so that the wheel 41 is pulled up together with the main body 20.

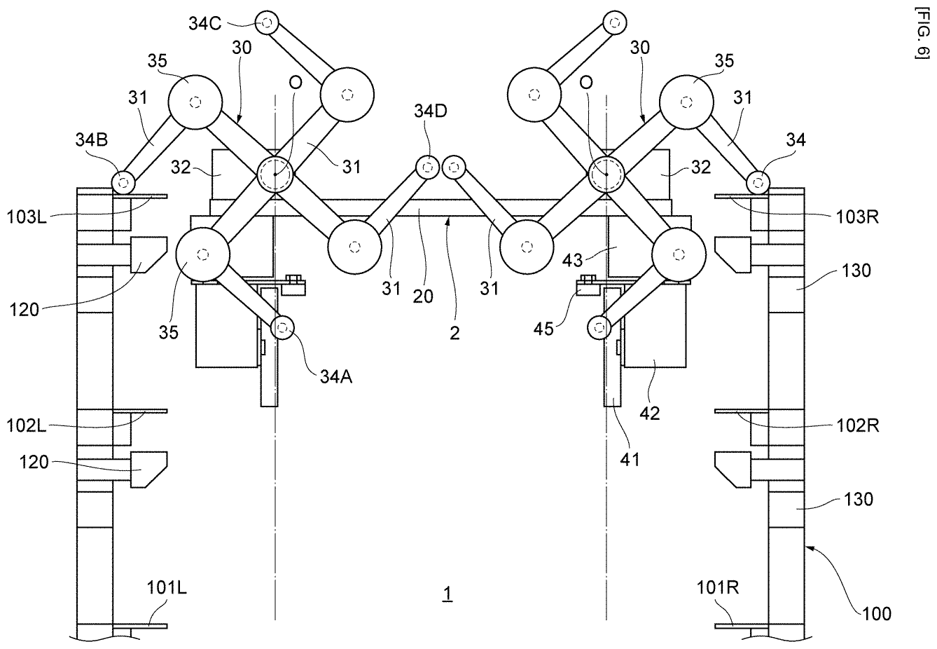

As illustrated in FIG. 6, when the wheel 41 is pulled up higher than the rails 102L and 102R of the lower stage, the wheel 41 is moved to immediately above the rails 102L and 102R of the lower stage using the rudder angle variable mechanism, and then, when the arm 31 is reversely rotated to separate the arm 31 from the rails 103L and 103R of the upper stage, the wheel 41 is landed on the rails 102L and 102R to be in the traveling mode again.

According to the above procedure, at an arbitrary place with respect to the extending direction of the rails 101L, 101R, the wheel 41 can be pulled up from the rails 101L, 101R to the rails 102L, 102R of the upper stage than the rails 101L, 101R, and the transport robot 2 can be raised at an arbitrary place of the structure 100. The transport robot 2 can also move from a flat place such as the direction changing space 140 instead of the rails 101L and 101R of the lower stage to the rails 102L and 102R of the upper stage by a similar procedure.

When the series of operations described with reference to FIGS. 3 to 6 is performed in the reverse order, the transport robot 2 can be lowered by lowering the wheels 41 from the rails 102L and 102R to the rails 101L and 101R of the lower stage than the rails 102L and 102R. That is, when the transport robot 2 is lowered in the structure 100 by switching from the traveling mode to the up/down mode, first, the arm 31 is rotated to lift the wheel 41.

Next, as shown in FIG. 6, the wheels 41 are retracted. When the arm 31 is brought close to the rails 102L and 102R of the lower stage while being hung on the rails 103L and 103R of the upper stage, as illustrated in FIG. 5, the arm 31 (second and fourth arms L2, R2) abuts on the rails 103L and 103R above the rotation center O, and the arm 31 (first and third arms L1, R1) abuts on the rails 102L and 102R below the rotation center O.

When the first and third arms L1 and R1 are further rotated from the state illustrated in FIG. 5, the scaffold supporting its own weight is switched from the rails 103L and 103R of the upper stage to the rails 102L and 102R of the lower stage as illustrated in FIG. 4. As illustrated in FIG. 4, the wheel 41 is lowered to the height of the rails 101L and 101R using the rails 102L and 102R as a scaffold.

The retracted wheel 41 is moved to immediately above the rails 101L and 101R, and as illustrated in FIG. 3, the arm 31 is further rotated to be spaced apart from the rails 102L and 102R, and the wheel 41 is landed on the rails 101L and 101R.

According to the above procedure, it is possible to lower the transport robot 2 by lowering the wheels 41 from the rails 102L and 102R to the rails 101L and 101R of the lower stage than the rails 102L and 102R at an arbitrary place of the rails 102L and 102R. The transport robot 2 can land on a flat place such as the direction changing space 140 instead of the rails 101L and 101R of the lower stage by a similar procedure.

Next, transport robots 2 according to second and third embodiments of the present invention will be described with reference to FIGS. 7 to 14. Note that configurations having the same or similar functions as those of the first embodiment are denoted by the same reference numerals, and the description of the corresponding first embodiment will be taken into consideration, and the description thereof will be omitted here. Other configurations are the same as those of the first embodiment.

### Second Embodiment

FIGS. 7 and 8 are perspective views showing a transport robot 2 according to a second embodiment of the present invention. FIG. 7 shows an example of the traveling mode in the minimum configuration, and FIG. 8 shows an example of the up/down mode in the minimum configuration. As illustrated in FIG. 7, the transport robot 2 of the second embodiment includes arm plates 30 provided two on each of the left and right sides of the main body 20, and a pair of left and right wheels 41. Each arm plate 30 includes only one arm 31. As illustrated in FIG. 8, the rudder angle variable mechanism according to the second embodiment can arrange the wheels 41 in the front-rear direction by turning the axle connecting the left and right wheels 41 by 90 degrees about the vertical axis. The width of the traveling mechanism 4 in the left-right direction is approximately the distance between the pair of wheels 41 in FIG. 7, and is the diameter of the wheels 41 in FIG. 8. Since the latter is narrower in width, the wheel 41 can be retracted from the rail.

The four arms 31 correspond to the first to fourth arms L1, L2, R1, and R2, respectively.

In FIG. 8, the first and third arms L1, R1 are located so as to be diagonal to the main body 20, and the second and fourth arms L2, R2 are located so as to be diagonal to the main body 20. Similarly to the first embodiment, in the transport robot 2 of the second embodiment, in a state in which the abutting portion 34A of one of the first and second arms L1 and L2 (e.g., the first arm L1) is abutted on the rail 102L of the lower stage located below the rotation center O of the arm, the abutting portion 34B of the other one of the first and second arms L1 and L2 (e.g., the second arm L2) is configured to abut on the rail 103L of the upper stage located above the rotation center O of the arm, and in a state in which the abutting portion 34A′ of one of the third and fourth arms R1 and R2 (e.g., the third arm R1) is abutted on the rail 102R of the lower stage located below the rotation center O of the arm, the abutting portion 34B′ of the other one of the third and fourth arms R1 and R2 (e.g., the fourth arm R2) is configured to abut on the rail 103R of the upper stage located above the rotation center O of the arm.

According to the second embodiment, similarly to the first embodiment, the transport robot 2 can move up/down at an arbitrary place of the structure 100 using the first to fourth arms L1, L2, R1, and R2. Although not illustrated, in the configuration of the transport robot 2, one arm plate 30 may be provided on each of the left and right sides of the main body 20. In this case, the left arm plate 30 may include at least one of each of the first and second arms L1 and L2, and the arm plate 30 on the right side may include at least one of each of the third and fourth arms R1 and R2.

### Third Embodiment

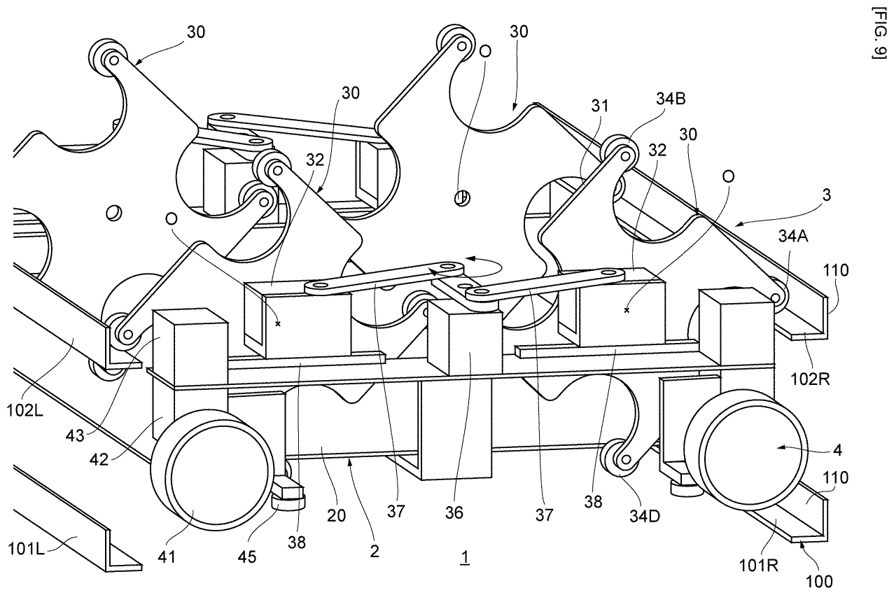

FIG. 9 is a perspective view illustrating an example of a transport robot 2 according to a third embodiment of the present invention. The transport robot 2 of the third embodiment includes an inter-center distance variable mechanism capable of changing the distance of the rotation center O of the arm plates 30 provided on the left and right of the main body 20 instead of the first guided portion 35. Here, since the rotation center of the arm plate 30 and the rotation center O of the arm 31 provided in the arm plate 30 are concentric, the inter-center distance variable mechanism changes the distance between the rotation center O of the arm 31 on the first side and the inter-center distance O of the arm 31 on the second side.

In FIG. 9, the inter-center distance variable mechanism is configured as a combination of a link mechanism (37, 38) including two sets of slider cranks with 4 links and 1 degree of freedom and an actuator 36 as a driving source of the link mechanism. The link mechanism (37, 38) converts the rotational motion input from the actuator 36 into a linear motion and slides the pair of left and right arm driving units 32 symmetrically.

The crank 37 constituting the link mechanism (37, 38) has one end connected to the output shaft of the actuator 36, and the other end connected to the top surface of the arm driving unit 32. The bottom surface of the arm driving unit 32 is connected to the slider 38 constituting the link mechanism (37, 38) and slides along the slider 38. Note that the inter-center distance variable mechanism is not limited to the illustrated example, and various known configurations can be selected.

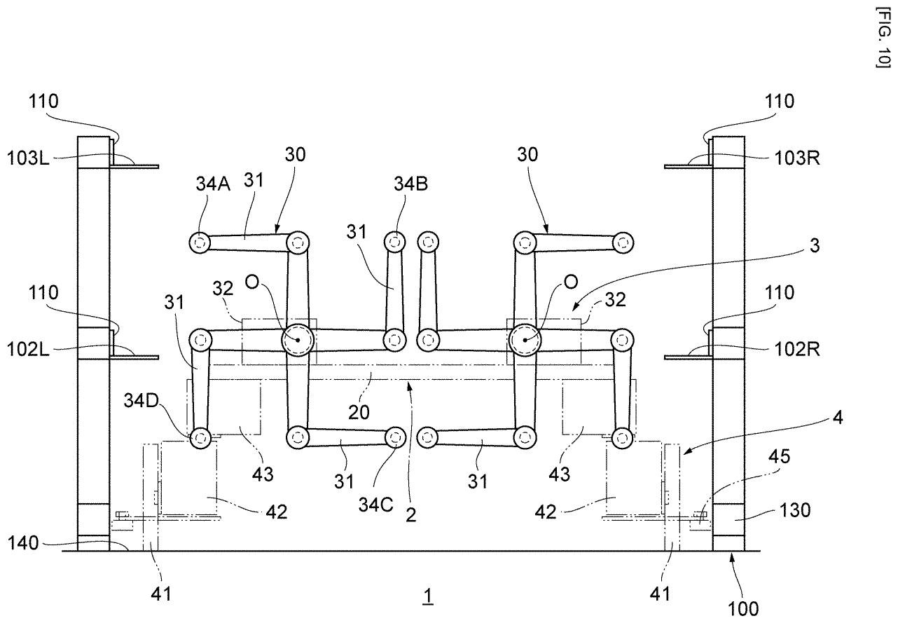

Next, an operation in which the transport robot 2 according to the third embodiment moves up/down the structure 100 will be described with reference to FIGS. 10 to 14. In the third embodiment, the first guided portion 35 described above may be omitted from the arm plate 30. At least one arm plate 30 is provided on each of the left side and the right side of the transport robot 2. Each arm plate 30 includes at least one arm 31. In FIG. 10, each arm plate 30 includes four arms 31 formed in a hooked cross shape and arranged at equal intervals of 90 degrees. In the present embodiment, two (that is, a total of four) arm plates 30 are provided on the front and rear sides in the depth direction in the plane of drawing on each of the left and right sides of the main body 20.

The arm plate 30 is installed in the arm driving unit 32 slidable in the horizontal direction (left and right). The arm driving units 32 provided on the left and right are each interlocked with the inter-center distance variable mechanism such as the actuator 36 and the link mechanisms (37 and 38) described above, and slide symmetrically to change the distance between the rotation centers O of the arm plates 30. In FIG. 10, the arm plate 30 is located on the inner side (main body 20 side) of the traveling mechanism 4.

In addition, in FIG. 10, edges 110 are provided at the left edges of the rails 102L to 103L on the left side and the right edges of the rails 102R to 103R on the right side, respectively, and the rails are formed to have an L-shaped cross section. In the traveling mode, the edge 110 functions as the traveling guide 130 and faces the second guided portion 45 in the left-right direction. In the up/down mode, the edge 110 functions as an up/down guide and faces the abutting portion 34A in the left-right direction.

The position of the rotation center O of the arm plate 30 is not particularly limited in the traveling mode or at the time of housing the transport robot. For example, as illustrated in FIG. 10, the distance between the pair of arm driving units 32 may be adjusted so that the distance between the rotation centers O of the pair of left and right arm plates 30 of the transport robot 2 becomes the shortest. Although not illustrated, the distance of the rotation centers O may be increased within a range in which the rails 102L and 102R and the arm 31 do not interfere with each other.

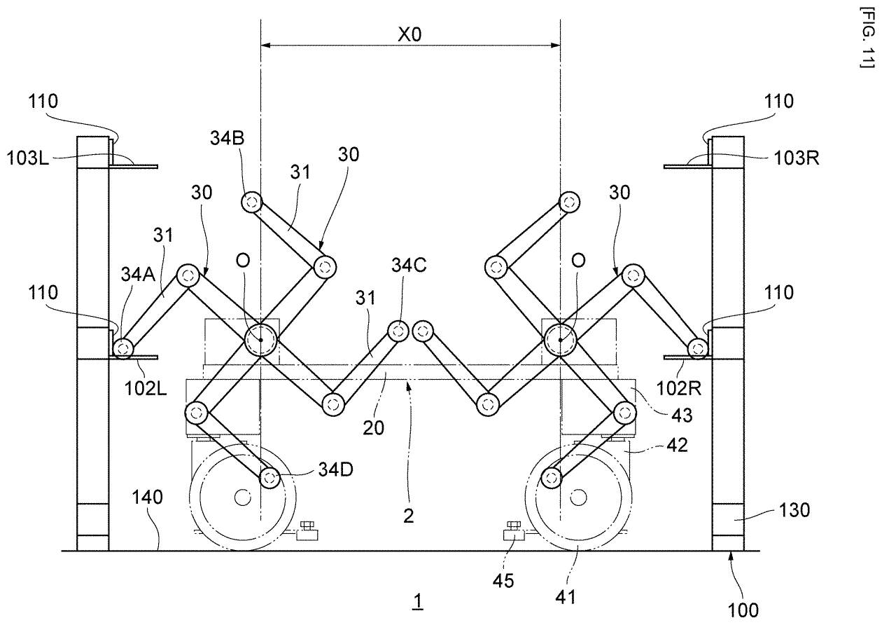

In the up/down mode, when the transport robot 2 moves up, as shown in FIG. 11, first, the transport robot 2 is steered by the turn driving unit 43 so that the rudder angle becomes approximately 90 degrees. Since each wheel 41 revolves 90 degrees around the output shaft of the turn driving unit 43, the wheel 41 on one of the left and right as viewed from the output shaft of the turn driving unit 43 moves to one of the front and rear as viewed from the output shaft and retracts to a position not interfering with the left and right rails 102L and 102R.

Next, the arm plate 30 is rotated while adjusting the distance between the pair of arm driving units 32 until the abutting portion 34A of the arm 31 is configured to abut on each edge 110 of the rails 102L and 102R. Each arm 31 attached to the arm plate 30 rotates according to the rotation of the arm plate 30 such that the abutting portion 34A draws a circular trajectory about the rotation center O. As described above, the rotation center O of the arm 31 is concentric with the rotation center of the arm plate 30. In FIG. 11, X0 represents the distance between the left and right rotation centers O.

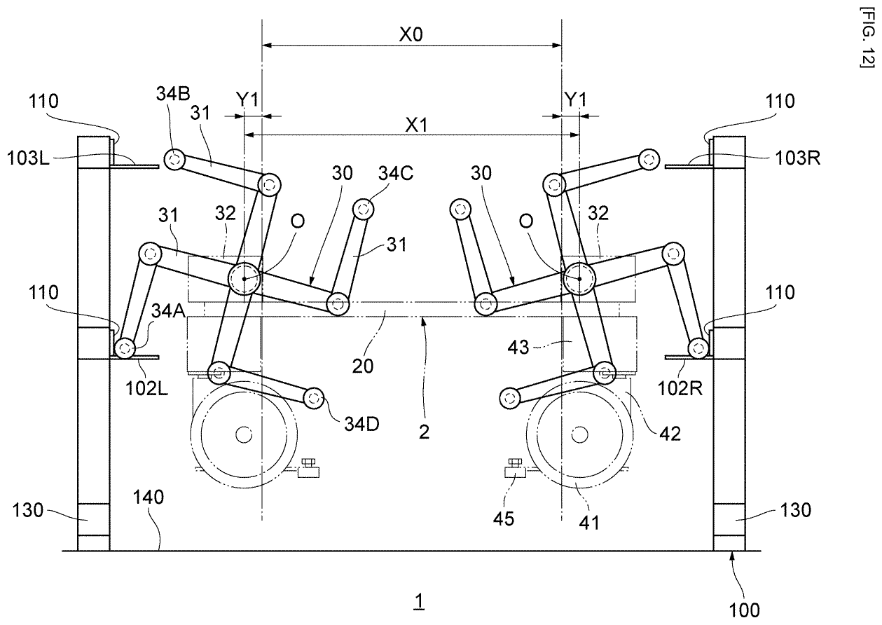

The arm plate 30 is further rotated while maintaining a state in which the abutting portion 34A of the arm 31 abuts on the edges 110 of the rails 102L and 102R, and the wheel 41 is pulled up together with the main body 20 using the rails 102L and 102R as a scaffold as illustrated in FIG. 12. In FIG. 12, X1 represents the inter-center distance of the rotation center O, and X0 represents the inter-center distance of the rotation center O illustrated in FIG. 11. That is, in the state of FIG. 11, the inter-center distance of the rotation center O is understood to be enlarged.

In the following drawings, similarly, X0 represents the inter-center distance between the rotation centers O in FIG. 11.

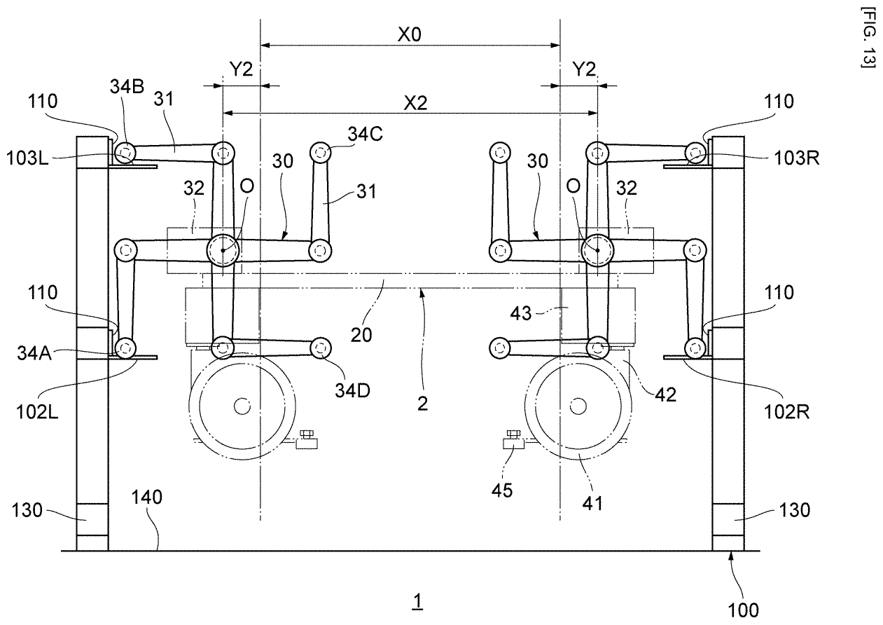

Next, when the arm plate 30 is further rotated while maintaining the state in which the abutting portion 34A of the arm 31 abuts on the edges 110 of the rails 102L and 102R, as illustrated in FIG. 13, the abutting portion 34B of another arm 31 abuts on the edges 110 of the rails 103L and 103R of the upper stage than the rails 102L and 102R. In the state illustrated in FIG. 13, the distance X2 between the rotation centers O is maximized in the up/down mode.

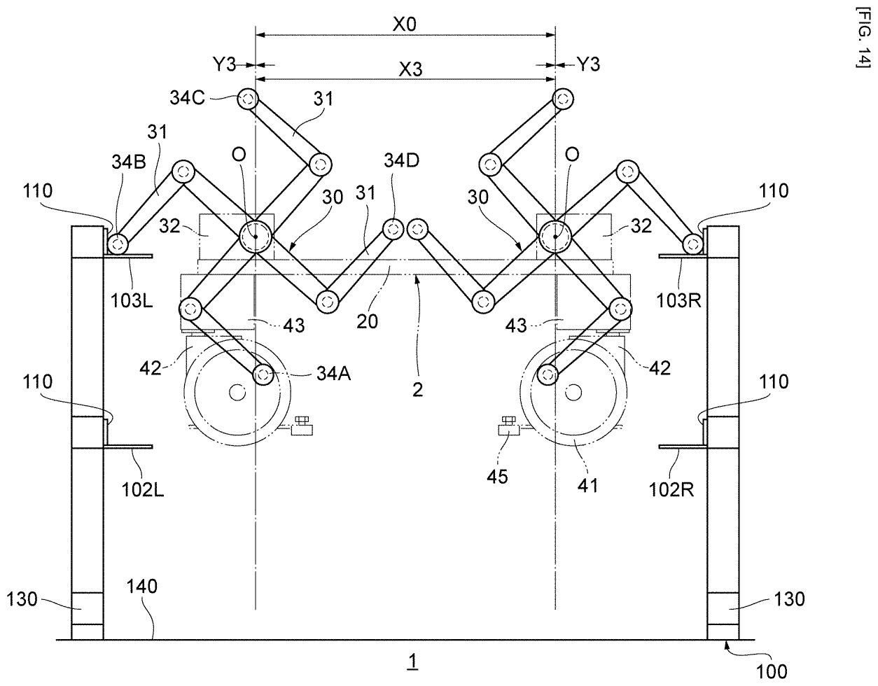

When the arm plate 30 is further rotated from the state illustrated in FIG. 13, as illustrated in FIG. 14, the scaffold supporting its own weight is switched from the rails 102L and 102R to the rails 103L and 103R of the upper stage than the rails 102L and 102R. With the rails 103L and 103R as the scaffold, the arm 31 can pull up the wheel 41 higher together with the main body 20.

In addition, as illustrated in FIG. 14, after the abutting portion 34A separates from the rails 102L and 102R, the contact portion with the abutting portion 34B of the edges 110 of 103L and 103R acts as a fulcrum, and the rotation centers O of the left and right arm plates 30 respectively slides toward the center side in the plane of drawing in conjunction with the rotational motion of the arm plate 30, so that the wheel 41 is pulled up together with the main body 20.

As illustrated in FIG. 14, when the wheel 41 is pulled up higher than the rails 102L and 102R of the lower stage, the wheel 41 can be placed on the rails 102L and 102R of the lower stage. Next, the wheel 41 is steered so as to be able to travel on the rails 102L and 102R, the wheel 41 is placed on the rails 102L and 102R, and thereafter, each rotation center O is further slid to the center side in the plane of drawing, and the arm is retracted to be in the traveling mode again.

According to the above procedure, at an arbitrary place with respect to the extending direction of the rails 102L to 103L and 102R to 103R, the transport robot 2 can be moved up at an arbitrary place of the structure 100 by pulling up the wheel 41 from a flat place such as a direction changing space or the rail of the lower stage to the rails 102L to 103L and 102R to 103R of the upper stage than the flat place or the rail of the lower stage.

In the first embodiment, the movement trajectory of the rotation center O is linear extending in the vertical direction in the up/down mode. On the other hand, in the third embodiment, as described above, the movement trajectory of the rotation center O moves in the left-right direction in the up/down mode. Specifically, the movement trajectory of the rotation center O in the third embodiment has an arc shape centered on the abutting portion 34A provided at the distal end of the arm 31. When the rotation center O is moved so as to draw such a trajectory, the abutting portion 34A moves so as to follow a predetermined position of the rail 102R.

According to the third embodiment, similarly to the first embodiment, the transport robot 2 can move up/down at an arbitrary place of the structure 100. Furthermore, the positional displacement between the arm 31 and the rail 102R can be prevented using the inter-center distance variable mechanism in the up/down mode. Furthermore, according to the transport robot 2 of the third embodiment, the distance between the arm 31 and each rail can be adjusted using the inter-center distance variable mechanism in the up/down mode, and thus, for example, even when the distance between the left and right rails is different in the traveling path, the transport robot 2 can move up/down at an arbitrary place of the structure 100.

The embodiments described above are intended to facilitate understanding of the present invention, and should not be construed as limiting the present invention. Each element included in the embodiment as well as the arrangement, material, condition, shape, size, and the like thereof are not limited to those exemplified, and can be appropriately changed. In addition, the configurations shown in different embodiments can be partially replaced or combined.

Furthermore, in particular, the number of the arms and the abutting portions is not limited to the above-described embodiment, and for example, a configuration merely including each of the arm on the first side, which has an abutting portion in contact with the rail and is turnably installed on the main body so that the abutting portion can be located on the first side of the main body, and the arm on the second side, which has an abutting portion in contact with the rail and is turnably installed on the main body so that the abutting portion can be located on the second side of the main body, may be adopted.

Even with such a configuration, by appropriately selecting the shape of the arm (shape of the member constituting the arm, combination angle of each member, size of each member, etc.), the position, the moving direction, and the moving distance of the rotation center of the arm, the rotation speed of each arm, the moving distance in the vertical direction with respect to the rotation angle of the abutting portion, and the like, the transport robot can be configured to move up/down between a plurality of pairs of rails arranged vertically in the structure in the present embodiment.

In addition, the configuration of retracting the wheel from the rail at the time of moving up/down may be a configuration of linearly moving the wheel in a direction orthogonal to the rail instead of retracting the wheel by changing the rudder angle as described above. For example, a transport body may be adopted that has a configuration of using a normal wheel in a configuration of simply linearly traveling in the front-back direction on a rail, and using a mecanum wheel when left and right, and rotation is required, so that the wheel is linearly moved in a direction (inner side) orthogonal to the rail at the time of moving up/down.

### Description of Symbols

1. transport system, 2. transport robot, 3. up/down mechanism, 4. traveling mechanism, 20. main body, 23. tray lift mechanism, 30. arm plate (an example of a rotating body), 31. arm, 32. arm driving unit, 34A, 34A′, 34B, 34B′, 34C, 34D. abutting portion, 35. first guided portion, 36. actuator, 37. crank, 38. slider, 41. wheel, 42. wheel driving unit, 43. turn driving unit (an example of a rudder angle variable mechanism), 45. second guided portion, 100. structure, 101L to 104L, 101R to 104R. rail, 110. edge of rail, 120. up/down guide, 130. traveling guide, L1. first arm, L2. second arm, O. rotation center, R1. third arm, R2. fourth arm, distance. X0, X1, X2.

1. A transport robot configured to execute an operation including a traveling mode and an up/down mode in a structure in which a plurality of pairs of rails extending along a traveling path of the transport robot are vertically arranged, the transport robot configured to travel along the rails in the traveling mode and configured to move up/down between each of the plurality of rails arranged vertically in the up/down mode; the transport robot comprising:
a main body; and
a plurality of rotating bodies provided in the main body and rotatable about a rotation axis along a direction in which the rails extend; wherein
the plurality of rotating bodies include
a first rotating body having at least one arm configured to abut on one of the rails on a first side which is one side in a traveling direction of the transport robot with respect to the main body, and
a second rotating body having at least one arm configured to abut on the other one of the rails on a second side which is the other side in the traveling direction of the transport robot with respect to the main body; and
in the up/down mode, the arm of the first rotating body and the arm of the second rotating body are rotated in opposite directions to each other to move up/ down between the pair of rails.

2. The transport robot according to claim 1, wherein
at least a first arm and a second arm are provided as the arm on the first side;
at least a third arm and a fourth arm are provided as the arm on the second side; and
in a mode in which the transport robot moves up/ down,
the first arm as well as the second arm, and the third arm as well as the fourth arm are rotated in opposite directions to each other to move up/down between the rails such that in a state in which one of the first arm and the second arm is configured to abut on the rail of a lower stage located below a rotation center of the arm, the other one of the first arm and the second arm is configured to abut on the rail of an upper stage located above the rotation center of the arm, and in a state in which one of the third arm and the fourth arm is configured to abut on the rail of the lower stage located below the rotation center of the arm, the other one of the third arm and the fourth arm is configured to abut on the rail of the upper stage located above the rotation center of the arm.

3. The transport robot according to claim 1, further comprising a pair of wheels; wherein
in a mode in which the transport robot travels, the wheel on the first side travels on the rail on the first side, and the wheel on the second side travels on the rail on the second side; and
in a mode in which the transport robot moves up/ down, the wheel on the first side is retracted to the second side than the rail on the first side, and the wheel on the second side is retracted to the first side than the rail on the second side.

4. The transport robot according to claim 3, further comprising a rudder angle variable mechanism configured to change a rudder angle of the pair of wheels; wherein
in a mode in which the transport robot moves up/ down, the rudder angle of the pair of wheels is changed by the rudder angle variable mechanism, the wheel on the first side is retracted to the second side than the rail on the first side, and the wheel on the second side is retracted to the first side than the rail on the second side.

5. The transport robot according to claim 4, wherein
at least two sets of the pair of wheels are provided, and a rudder angle of each of the wheels is individually changed.

6. The transport robot according to claim 3, further comprising a wheel moving mechanism configured to move the pair of wheels in a direction orthogonal to a direction in which the rails extend; wherein
in a mode in which the transport robot moves up/down, an interval between the pair of wheels is changed by the wheel moving mechanism;
the wheel on the first side is retracted to the second side than the rail on the first side, and the wheel on the second side is retracted to the first side than the rail on the second side.

7. The transport robot according to claim 3, further comprising a second guided portion configured to restrict movement of the transport robot toward the first side or the second side by abutting on the structure in a mode in which the transport robot travels; wherein
the second guided portion configured to restrict the movement to the first side is attached to the wheel on the first side and projects out further to the first side than the wheel; and
the second guided portion configured to restrict the movement to the second side is attached to the wheel on the second side and projects out further to the second side than the wheel.

8. The transport robot according to claim 1, further comprising a first guided portion configured to restrict movement of the transport robot toward the first side or the second side by abutting on the structure in a mode in which the transport robot moves up/down; wherein
the first guided portion configured to restrict the movement to the first side is provided between an abutting portion of the arm on the first side and a rotation center of the arm, and
the first guided portion configured to restrict the movement to the second side is provided between a distal end of the arm on the second side and a rotation center of the arm.

9. The transport robot according to claim 8, wherein the first guided portion is a circular member.

10. The transport robot according to claim 1, further comprising an inter-center distance variable mechanism configured to change a distance between a rotation center of the arm on the first side and a rotation center on the second side.

11. A transport system comprising:
a structure in which a plurality of pairs of rails are vertically arranged; and
a transport robot configured to travel on the rails in the structure and configured to move up/down between the plurality of rails arranged vertically; wherein
the transport robot includes,
a main body, and
a plurality of rotating bodies provided in the main body and rotatable about a rotation axis along a direction in which the rails extend;
the plurality of rotating bodies include
a first rotating body having at least one arm configured to abut on one of the rails on a first side which is one side in a traveling direction of the transport robot with respect to the main body, and
a second rotating body having at least one arm configured to abut on the other one of the rails on a second side which is the other side in the traveling direction of the transport robot with respect to the main body; and
in the up/down mode, the arm of the first rotating body and the arm of the second rotating body rotate in opposite directions to each other to move up/down between the pair of rails.

12. The transport system according to claim 11, wherein the structure further includes an up/down guide provided between the rail of an upper stage and the rail of a lower stage;
the transport robot further includes a first guided portion configured to restrict movement of the transport robot toward the first side or the second side by abutting on the up/down guide in a mode in which the transport robot moves up/down;
the first guided portion configured to restrict the movement to the first side is provided between a distal end of the arm on the first side and a rotation center of the arm; and
the first guided portion configured to restrict the movement to the second side is provided between at least one distal end of the arm on the second side and a rotation center of the arm.
